(19) United States
(12) Patent Application Publication
(10) Pub. No.: US 2009/0196597 A1
(43) Pub. Date: Aug. 6, 2009

(54) Mounting and Positioning System

(76) Inventors: Gioia Messinger, Encinitas, CA (US); Andrew Paul, San Diego, CA (US); Andrew Zoolakis, Carlsbad, CA (US)

Correspondence Address: WILLIAM J. KOLEGRAFF, 3119 TURNBERRY WAY, JAMUL, CA, 91935, US

(21) Appl. No.: 12/023,866

(22) Filed: Jan. 31, 2008

(51) Int. Cl. G03B 17/00; H04N 7/18

(52) U.S. Cl. 396/427; 348/143; 348/E07.085

(57) ABSTRACT

A magnetic mount is provided for easily mounting, positioning, and orienting a camera, sensor or other directionally sensitive electronic device. In one example the magnetic mount is a camera mount. The camera mount has a camera part that has an image sensor, electronics, battery, and communication components. The housing for the camera part has a generally concave mounting surface, with a magnet positioned inside the camera housing and adjacent to the camera mounting surface. A base part has a base mounting surface that is constructed to be attracted to the magnet. In one example, the base mounting surface is dome-shaped, with a convex curvature constructed to mate with the concave curvature of the camera mounting surface. The base part is mounted to a stable support, and the camera mounting surface brought near the base counting surface. The magnetic attractive forces pull the camera part firmly to the base part, thereby securely positioning and orienting the camera. However, the camera may be readily repositioned by pushing the camera into a new position. The size and shape of the complementary mounting surfaces may be selected according to positioning requirements.

### FIELD OF THE INVENTION

The present invention relates to a mechanical device for mounting and positioning directionally sensitive electronic apparatus. In one example, the mount is constructed for holding and positioning a small camera.

### BACKGROUND

The field of remote image capture is growing rapidly. Remote image capture has been found to be useful in security applications, as well as for monitoring environmental, commercial and industrial processes. In a typical remote imaging application, cameras are mounted in strategic positions in an area, and the cameras communicate image or video data to a central monitoring station. In one example, the remote imager is an Internet camera that communicates image data to a computer attached to the Internet. In another example, the remote imagers are miniature cameras that communicate on a private network. Once such camera and camera network is described in co-pending U.S. application Ser. No. 11/847,471, entitled “Network Sensor System and Protocol”, which is incorporated herein. It will be understood that many other different types of sensors, imagers, and cameras may be used in a remote imaging application.

In setting up a remote monitoring system, each camera is usually mounted to a stable support surface, with the camera's imager being directed toward an area of interest. To facilitate a more flexible installation, cameras are often mounted using a ball-andjoint or universal camera bracket. In using such a bracket, each camera is usually screwed or bolted to a first part of the bracket, and then the first part of the bracket frictionally engaged to a second part of the bracket. In this way, initially attaching a camera to a bracket often requires the use of tools, and can be a time consuming and cumbersome process. For example, the camera is easily dropped and damaged during the installation process. In a similar manner, removing a camera from its mounting bracket suffers from the same deficiencies. After installation, these brackets allow the camera to be tilted and panned to a particular position, and then a mechanical locking mechanism secures the camera into that position. If the camera positioning needs to be adjusted, the locking mechanism is loosened, the camera repositioned, and then the locking mechanism is tightened. In this way, repositioning cameras can also be a time consuming and cumbersome process. In another disadvantage, the locking mechanism or the ball-andjoint structure may interfere with positioning, thereby limiting how the camera can be positioned.

Accordingly, there is a need for a camera mount that allows for simple installation and removal of a camera, while enabling flexible positioning and orientation.

### SUMMARY OF THE INVENTION

Briefly, the present invention provides a magnetic directional mount for easily mounting, positioning, and orienting an electronic device. The device may be a camera or other sensor device, or may be another directionally sensitive device such as a microwave or radio wave antenna. When constructed as a camera mount, the camera mount has a camera part that has an image sensor, electronics, battery, and communication components. The housing for the camera part has a generally concave mounting surface, with a magnet positioned inside the camera housing and adjacent to the camera mounting surface. A base part has a base mounting surface that is constructed to be attracted to the magnet. In one example, the base mounting surface is dome-shaped, with a convex curvature constructed to mate with the concave curvature of the camera mounting surface. The base part is mounted to a stable support, and the camera mounting surface brought near the base counting surface. The magnetic attractive forces pulls the camera part firmly to the base part, thereby securely positioning and orienting the camera. However, the camera may be readily repositioned by pushing the camera into a new position. The size and shape of the complementary mounting surfaces may be selected according to positioning requirements.

Advantageously, the mounting system provides a 3-dimension universal positioning mechanism for the camera or other electronic device. The camera may be easily attached or detached from its base part. Further, the camera may be easily adjusted for optimum positioning and orientation. Finally, because the camera mount system has no ball or joint structure, the camera may be freely moved into any position on the base mounting surface. It will be appreciated that the size and shape of the base mounting surface may be adjusted according to how much orientation flexibility is required. For example, the base mounting surface may be dome-shaped. The dome is typically a hemi-sphere or quarter-dome, but may be constructed to be nearly fully spherical in shape, thereby allowing a broader range of orientation. Similarly, if less flexibility is needed, the size and shape of the dome may be reduced.

### BRIEF DESCRIPTION OF THE DRAWINGS

FIG. 1 is a block diagram of a camera mounting system in accordance with the present invention.

FIG. 2 is a block diagram of a camera mounting system in accordance with the present invention.

FIG. 3 is a block diagram of a camera mounting system in accordance with the present invention.

FIG. 4 is an illustration of a camera mounting system in accordance with the present invention.

FIG. 5 is an illustration of a camera for use with a camera mounting system in accordance with the present invention.

FIG. 6 is a transparent illustration of a camera for use with a camera mounting system in accordance with the present invention.

FIG. 7 is a transparent illustration of a dome-shaped base for use with a camera mounting system in accordance with the present invention.

FIG. 8 is a block diagram of a camera mounting system in accordance with the present invention.

FIG. 9 is a block diagram of a camera mounting system in accordance with the present invention.

### DETAILED DESCRIPTION OF THE PREFERRED EMBODIMENT

Referring now to FIG. 1, a directional mount system is illustrated. The directional mount system of FIG. 1 is shown in the form of a camera mount 10, but it will be appreciated that other types of mounts may be constructed. For example, the directional mount may be used for other types of image or video sensors, or may be used to mount directionally sensitive electronic devices such as microwave, satellite, or RF antennas. Camera mount system 10 may be used to advantageously and flexibly mount a camera to a supporting base. The camera may be a miniature camera, for example, like the camera described in co-pending U.S. application Ser. No. 11/847,471, entitled “Network Sensor System and Protocol”. It will be appreciated that other image or video cameras may be used. Camera mount system 10 comprises a base portion 12 and a cooperating camera portion 14. Base portion 12 has a convex surface 17 attached to a mounting base 19. Mounting base 19 is constructed to be securely attached to a stable support such as a wall, pole, or other fixed object. The mounting base may be adhesively or mechanically attached to the stable support, and may be permanently for removably fixed.

In one example, the convex surface 17 is in the shape of a dome. The dome may be spherically shaped, or may have a different aspect ratio, such as an elliptical shape. The dome may be, for example, a hemisphere, which is conveniently shaped for mounting on a wall surface. In another example, the dome may be a half dome, which fits conveniently at the intersection of two surfaces, or the dome may be a quarter dome which fits conveniently at the intersection of three surfaces. It will be appreciated that the size and shape of the dome may be adjusted according to specific mounting and directional requirements. Typically, the dome 17 will have a smooth surface, although protrusions may be added for providing particular stop positions. The dome 17 is typically constructed of a material that is attracted by magnetic force, such as a ferrous or metallic material. The dome may be entirely constructed of such magnetic -material, or may have a coating or layer on its inner or outer surface for providing such attraction. It will also be appreciated that the dome 17 and the mountain base 19 may be integrally formed, or be made of separate pieces.

The camera portion 14 has a housing 22 for holding an image sensor 28 and supporting electronic and communication circuitry. Also, the housing 22 may hold a battery for providing power for sensor 28 and the electronic circuitry. Housing 22 has a concave portion 24 sized to cooperatively mate with the domed surface 17. A magnet 26 is mounted in the housing adjacent to the concave surface 24. It will be appreciated that magnet 26 may be a button magnet, strip magnet, or other shaped magnetic device. Although magnet 26 is contemplated to be a permanent magnet, in some cases an electromagnet or other temporary magnet may also be used.

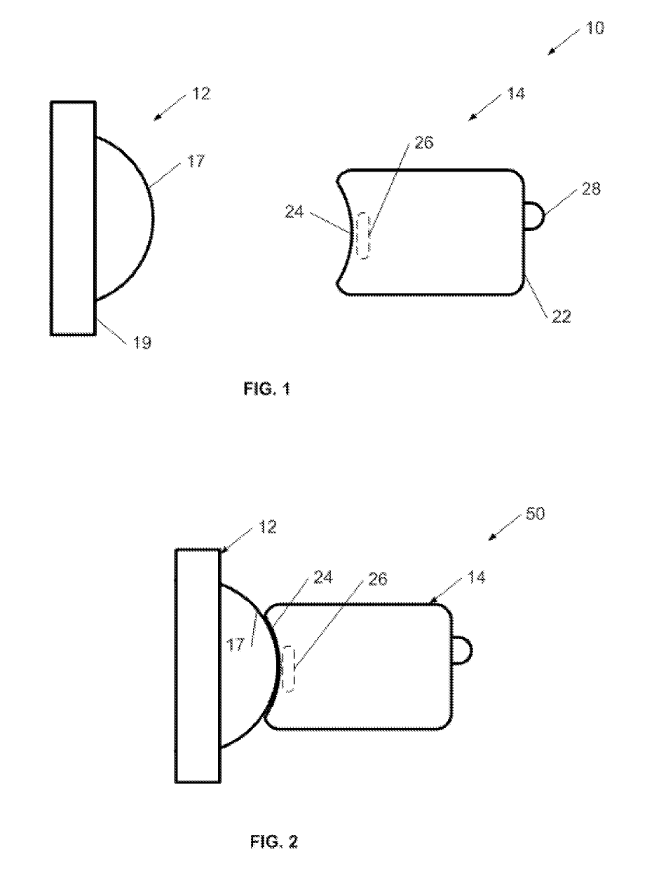

To position and orient a camera, the base portion 12 is securely attached to a stable surface. The camera portion 14 is simply brought near the base part 12, so that the dome convex surface 17 is brought into contact with the concave surface 24 on the camera housing 22 as illustrated in FIG. 2. In this arrangement, the magnet acts to pull concave surface 24 toward the fixed domed surface 17, since domed surface 17 is attracted by magnetic force. Magnet 26 is sized sufficiently to hold the camera part 14 securely to the dome 17. However, due to the complementary shapes of the dome 17 and concave surface 24, the camera may be moved into an infinite number of positions relative to the dome

In this way, camera mount system 50 provides a universal positioning mechanism for camera 14. Advantageously, camera 14 may be easily attached or detached from its base part 12. Further, camera 14 may be easily adjusted for optimum positioning and orientation. Finally, because the camera mount system 50 has no ball or joint structure, the camera 14 may be freely moved into any position on the dome 17. It will be appreciated that the size and shape of the dome 17 may be adjusted according to how much orientation flexibility is required. For example, dome 17 may be nearly fully spherical in shape, thereby allowing a broader range of orientation. Similarly, if less flexibility is needed, the size and shape of dome 17 may be reduced. Although FIGS. 1 and 2 show camera 14 moving in two dimensions, it will be appreciated that camera mount 50 enables a full three-dimensional pan and tilt function.

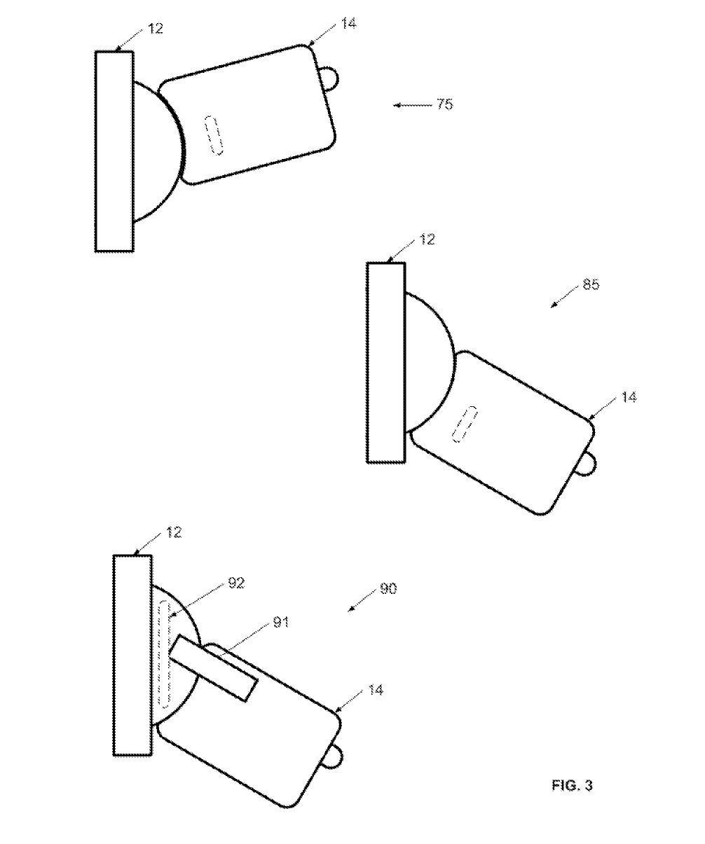

Referring now to FIG. 3, position 75 shows a camera mount system with camera 14 having a generally upward orientation in relation to camera mount 12. By simply pushing downward on camera 14, camera 14 may be moved into the downward orientation shown in position 85. It will be appreciated that camera 14 may be infinitely positioned with respect to base 12.

Camera mount 90 shows just two alternatives that may be readily made to the directional mount. In one alternative, a locking mechanism 91 is provided. The locking mechanism 91 is disengaged while the camera 14 is moved into position, and then tightened or engaged when the camera is properly placed. In this way, the camera 14 may easily be repositioned using the dome and magnet structure, but may be held fixedly in place by the locking mechanism 91 after the camera is in the desired orientation. Such a locking mechanism would also be useful in other mounting devices, such as mount for a satellite dish. In this construction, the magnetic mounting structures may be used to readily position the satellite dish into its optimal position, and when properly place, the locking mechanism is engaged to fix the satellite dish into place. With the locking mechanism engaged, movement due to wind, vibration, or bumping may be avoided. It will be appreciated that the locking mechanism may take several alternative forms, such as lock screw, set screw, adhesive, straps, or snaps, or other mechanical locking structures.

Mount 90 also shows another alternative where the magnet 92 is positioned in the dome, instead of in the camera. The magnet 92 may be a single magnet, such as a bar magnet, or may be a set of magnets, such as a set of button magnets. Although magnet 90 is typically a permanent magnet, an electro magnet may be substituted in some systems.

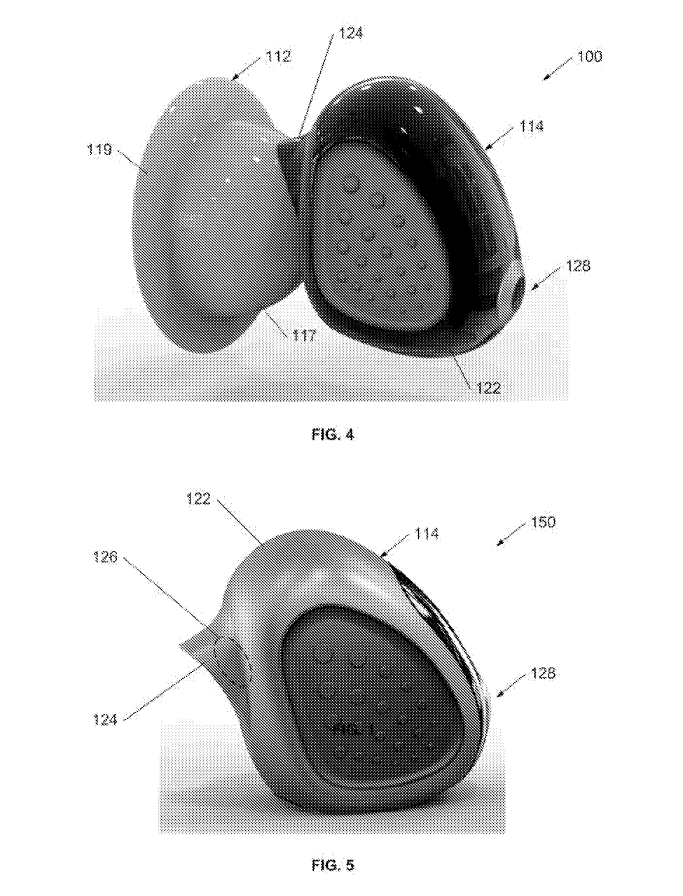

Referring now to FIG. 4, a specific commercial embodiment of a camera mount system 100 is illustrated. Camera mount 100 is similar to camera mount 50 described previously so will not be described in detail. Camera mount 100 has a base portion 112 cooperating with a camera portion 114. Base portion 112 has a base portion 119 having a convex dome 117. Base parts 112 and 119 are integrally formed, and dome 117 has a material that is attracted to a magnetic force.

Camera portion 114 has a housing 122 holding an image sensor 128. Image sensor 128 may be, for example, a CCD sensor for taking image or video information. Electronic components within housing 122 are used for capturing, processing, and communicating the image or video information. Housing 122 has a concave portion 124 constructed to mate and cooperate with dome surface 117. A magnet (not shown) is positioned inside housing 122 adjacent to the concave surface 124. Accordingly, when camera portion 114 is brought near base portion 112, the magnet is drawn toward dome base 117, thereby frictionally holding camera portion 114 against base portion 112. Although camera 114 is securely frictionally coupled to base portion 112, the camera 114 may be readily repositioned on dome 117.

Referring now to FIG. 5, a side view of a camera portion 115 is illustrated. Illustration 150 shows camera portion 114 having a concave surface 124 sized and shaped to cooperate with the dome 117 on base portion 112. A magnet 126 is positioned inside the housing 122 for cooperating with dome 117. It will be appreciated that the size and shape of the cooperating concave and convex surfaces may be adjusted according to application needs.

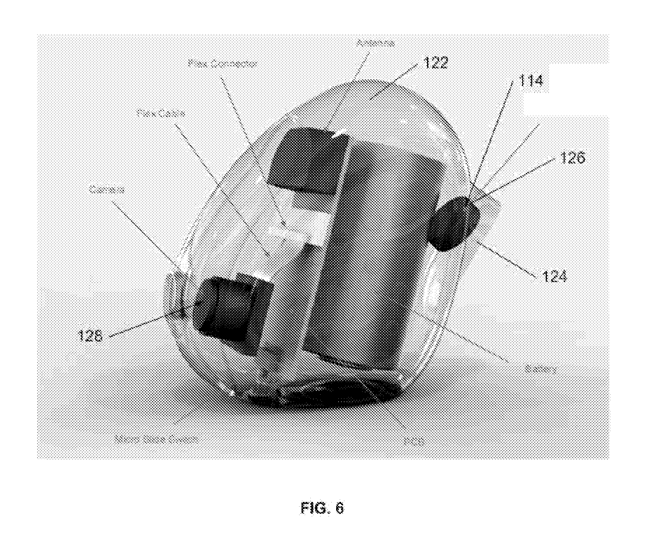

Referring now to FIG. 6, a transparent view of a camera portion 114 is illustrated. Camera portion 114 has a housing 122 for holding the image sensor 128 along with associated battery, electronic, and communication components. The housing 122 also has a concave cooperating surface 126. A magnet 124 is located within housing 122 adjacent to concave surface 126. In this orientation, the magnet 124 is able to attract the cooperating dome surface 117. It will be appreciated that many other specific internal constructions may be used.

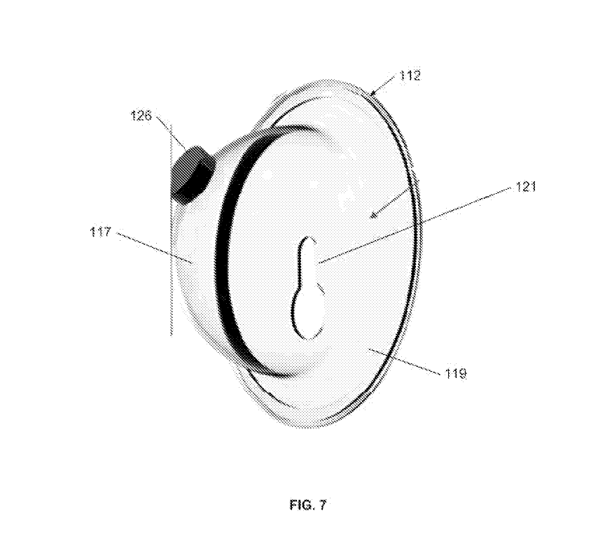

Referring now to FIG. 7, a transparent view of a supporting base 112 is illustrated. Base 112 has a base portion 119 and a domed surface 117. Domed surface 117 is typically made of a material attracted to magnetic force, and is sized and shaped to cooperate with the concave surface on a cooperating camera housing. In this illustration, base portion 112 has a slot 121 for receiving the head of a screw or nail. In this way, base 112 may be readily attached to a supporting structure using a screw or nail. Although not part of the base 112, a magnet 126 is illustrated attached to the magnetic dome, illustrating that dome 117 is attracted by magnetic force. In operation, magnet 126 would be internal to a camera housing 122.

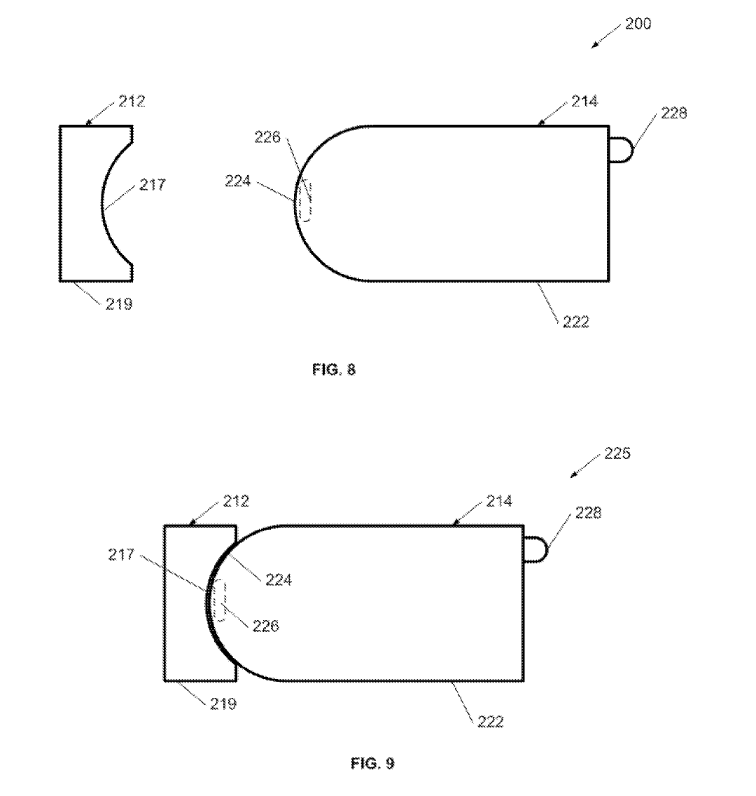

Although the camera mount has been described as having the concave surface on the camera portion and the convex surface on the mount, it will be appreciated that other constructions may be provided. For example, FIG. 8 shows a camera portion 214 having a convex surface 226 on its housing 222. The housing 222 holds an imager 228, associated electronics and communication electronics, and a magnet 224. Magnet 224 is positioned to attract the concave surface 217 on base part 212. Base part 212 also has a mounting base 219. In operation, as shown in FIG. 9, the magnet 226 draws convex surface 224 against concave surface 217, thereby securing the camera portion 214 into a stable position and orientation. However, the camera 214 may be readily moved into an infinite number of pan and tilt positions. It will be appreciated that although concave surface 217 is illustrated in two dimensions, in practice concave surface 217 is bowl shaped.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A camera mount system for a miniature camera, comprising:
a generally concave camera mounting surface on the miniature camera;
a magnet in the miniature camera and positioned adjacent the camera mounting surface;
a base having a base mounting surface that is attracted to the magnet; and
wherein the magnet couples the camera to the base when the camera mounting surface is adjacent the base mounting surface.

2. The camera system according to claim 1, wherein the camera mounting surface is generally dome shaped.

3. The camera system according to claim 1, wherein the dome shape is a full dome, a half dome, or a quarter dome.

4. The camera system according to claim 1, wherein the camera mounting surface is generally spherically or elliptically shaped.

5. The camera system according to claim 1, wherein the base is substantially comprised of the magnet attracting material.

6. The camera system according to claim 1, wherein the base has a coating or a layer of the magnet attracting material.

7. The camera system according to claim 1, wherein the base is constructed from a metal.

8. A camera system, comprising:
a camera mounting surface integrally formed on a camera;
a magnet in the camera and positioned adjacent the camera mounting surface;
a base part having a base mounting surface that is attracted to the magnet, and constructed to mate with the camera mounting surface; and
wherein the magnet couples the camera to the base when the camera mounting surface is adjacent the base mounting surface.

9. The camera system according to claim 8, wherein:
the base mounting surface is dome shaped; and
the camera mounting surface is concave to mate with the shape of the base mounting surface.

10. The camera system according to claim 8, wherein:
the base mounting surface is spherical or eliptically shaped; and
the camera mounting surface is concave to mate with the shape of the base mounting surface.

11. The camera system according to claim 8, wherein:
the base mounting surface is dome shaped as a full dome, a half dome, or a quarter dome; and
the camera mounting surface is concave to mate with the shape of the base mounting surface.

12. A camera mount system, comprising:
a first camera mount part having a concave mounting surface;
a second camera mount part having a convex mounting surface shaped to mate with the concave mounting surface;
a magnet positioned to releasably couple the concave mounting surface to the convex mounting surface.

13. The camera mount system according to claim 12, wherein:
the first camera mount part is a camera housing;
the concave mounting surface is on the camera housing;
the second camera mount part is a mounting base;
the convex mounting surface is on the mounting base; and
the magnet is in the camera housing and positioned adjacent the concave mounting surface.

14. The camera mount system according to claim 12, wherein:
the first camera mount part is integrally formed on a miniature camera;
the second camera mount part is a mounting base;
the convex mounting surface is generally dome shaped and on the mounting base; and
the magnet is in the miniature camera housing and positioned adjacent the concave mounting surface.

15. The camera mount system according to claim 12, wherein:
the first camera mount part is a camera housing;
the convex mounting surface is on the camera housing;
the second camera mount part is a mounting base;
the concave mounting surface is on the mounting base; and
the magnet is in the camera housing and positioned adjacent the convex mounting surface.

16. The camera mount system according to claim 12, wherein:
the first camera mount part is a camera housing;
the concave mounting surface is on the camera housing;
the second camera mount part is a mounting base;
the convex mounting surface is on the mounting base; and
the magnet is in the mounting base and positioned adjacent the convex mounting surface.

17. A directional mount system, comprising:
a first directional mount part having a concave mounting surface;
a second directional mount part having a convex mounting surface shaped to mate with the concave mounting surface;
a magnet positioned to releasably couple the concave mounting surface to the convex mounting surface.

18. The directional mount system according to claim 17, wherein:
the first directional mount part is a housing for an electronic device;
the concave mounting surface is on the housing;
the second directional mount part is a mounting base;
the convex mounting surface is on the mounting base; and
the magnet is in the housing and positioned adjacent the concave mounting surface.

19. The directional mount system according to claim 17, wherein:
the first directional mount part is integrally formed on a housing for an electronic device;
the second directional mount part is a mounting base;
the convex mounting surface is generally dome shaped and on the mounting base; and
the magnet is in the housing and positioned adjacent the concave mounting surface.

20. The directional mount system according to claim 17, wherein:
the first directional mount part is a housing;
the convex mounting surface is on the housing;
the second directional mount part is a mounting base; and
the concave mounting surface is on the mounting base.
